(19) United States
(12) Patent Application Publication
(10) Pub. No.: US 2010/0296267 A1
(43) Pub. Date: Nov. 25, 2010

(54) LAMP STRUCTURE FOR ILLUMINATING AND DISPLAYING

(75) Inventors: Ching-Hui Yu, Jhubei City (TW); Chih-Chen Chen, Jhubei City (TW)

Correspondence Address: STITES & HARBISON PLLC, Suite 900, 1199 N. Fairfax, Alexandria, VA, 22314, US

(73) Assignee: Power Light Tech. Co., Ltd., Jhubei City (TW)

(21) Appl. No.: 12/507,945

(22) Filed: Jul. 23, 2009

(30) Foreign Application Priority Data
May 25, 2009 (TW) 098117282

(51) Int. Cl. F21V 33/00

(52) U.S. Cl. 362/85

(57) ABSTRACT

The present invention discloses a lamp structure for illuminating and displaying. The lamp structure includes a lamp support, an elevator module, a lighting-displaying module and a control module. The elevator module is combined with a rod of the lamp support. The lighting-displaying module is combined with the elevator module to elevate or lower with the movement of the elevator module and the control module is used to control the elevator module. The lighting-displaying module elevating with the elevator module to a first location is switched to an illumination mode for illuminating, while the lighting-displaying module lowering with the elevator module to a second location is switched to a display mode for displaying. The elevator module is controlled by the control module to elevate or lower so that the lighting-displaying module is at an appropriate location for illuminating or displaying to extend the application field of the lamp structure.

### BACKGROUND OF THE INVENTION

1. Technical Field

The present invention relates to lamps, and more particularly, to a lamp structure, acting as a streetlamp, for illuminating and displaying.

2. Description of Related Art

FIG. 1 depicts a conventional streetlamp structure. As can be seen in FIG. 1, the streetlamp structure comprises a lamp support 10, a lamp housing 11, and a lighting module 13. The lamp support 10 is one typically used for streetlamps and the lamp housing 11 is connected with one end of the lamp support 10. The lighting module 13 is an illuminant, such as an LED array, and is disposed in the lamp housing 11 to emit light downward, thereby providing illumination in the dusk and at night.

However, since the lighting module 13 is fixedly assembled in the streetlamp structure, it functions for nothing but illumination. Besides, since the streetlamp structure only operates in the dusk and at night, the lighting module 13 is left idle in the daytime or when sunlight is sufficient.

On the other hand, display boards using LED arrays for advertisement or traffic instruction are commonly provided beside the roads and serve only to present information. Both the aforementioned display boards and streetlamps only function for a respective purpose but fail to be applied in a versatile manner. However, since the lighting module 13 of a streetlamp and a display board are both constructed from light-emitting diodes, the combination of the both makes a versatile and thus extends the application of field of the lamp structure.

### SUMMARY OF THE INVENTION

One objective of the present invention is to provide a lamp structure for illuminating and displaying, wherein the lamp structure implements an elevator module to displace and position a lighting-displaying module so that the lighting-displaying module serves alternatively for illuminating and displaying.

Another objective of the present invention is to provide a lamp structure for illuminating and displaying, wherein the lamp structure uses a control module to move an elevator module so that the elevator module is able to elevate or lower with time or ambient illumination conditions to move the lighting-displaying module and further allow the same to function for illuminating or displaying.

To achieve these and other objectives of the present invention, the lamp structure comprises: a lamp support having a rod; an elevator module combined with the lamp support; a lighting-displaying module combined with the elevator module to elevate or lower with movements of the elevator module, wherein the lighting-displaying module elevating with the elevator module to a first location of the lamp support is for illuminating, while the lighting-displaying module lowering with the elevator module to a second location of the lamp support is for displaying; and a control module electrically connected with the elevator module for controlling the elevator module to elevate or lower and switching the lighting-displaying module between an illumination mode for illuminating and a display mode for displaying.

By implementing the present invention, at least the following progressive functions can be achieved:

1. The lamp structure uses the elevator module to displace and position the lighting-displaying module so that the lighting-displaying module is able to serve alternatively for illuminating and displaying; and

2. The lamp structure uses the lighting-displaying module to provide illumination or display as needed so that the lighting-displaying module is efficiently and versatilely utilized.

### BRIEF DESCRIPTION OF THE DRAWINGS

The invention as well as a preferred mode of use, further objectives and advantages thereof will be best understood by reference to the following detailed description of illustrative embodiments when acquire in conjunction with the accompanying drawings, wherein:

FIG. 1 is a perspective view of a conventional streetlamp structure;

FIG. 2 is a schematic drawing of a lamp structure according to a first embodiment of the present invention;

FIG. 3 is a sectional view of a lamp structure according to a second embodiment of the present invention;

FIG. 4 is a sectional view of a lamp structure according to a third embodiment of the present invention;

FIG. 5 is a block diagram of a circuit according to a first concept of the present invention;

FIG. 6 is a flow chart showing operation of the circuit of FIG. 5;

FIG. 7 is a block diagram of a circuit according to a second concept of the present invention; and

FIG. 8 is a flow chart showing operation of the circuit of FIG. 7.

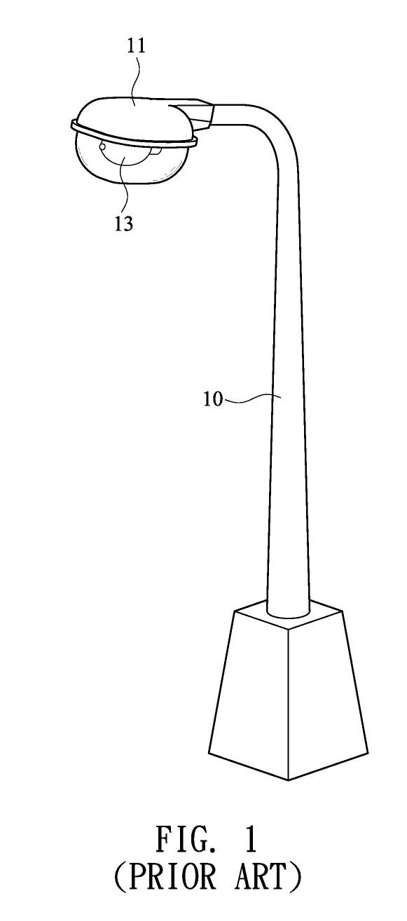

### DETAILED DESCRIPTION OF THE PREFERRED EMBODIMENTS

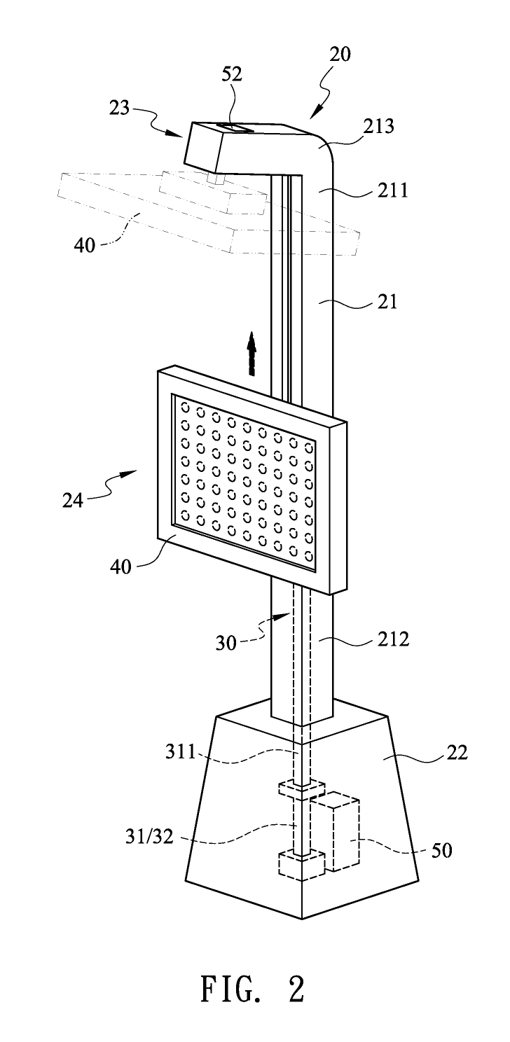

Referring to FIG. 2, a lamp structure for illuminating and displaying according to the present invention includes a lamp support 20, an elevator module 30, a lighting-displaying module 40, and a control module 50.

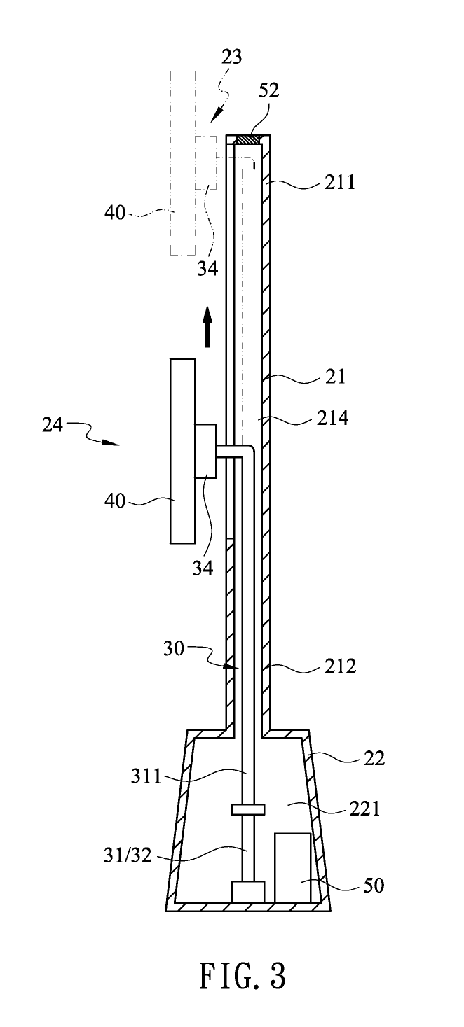

As shown in the drawing, the lamp support 20 has a rod 21, which may be a hollow rod including therein a chamber 241 (as shown in FIG. 3) for receiving the elevator module 30 and the control module 50. The rod 21 has a first end 211 and a second end 212. Therein, the first end 211 refers to the upper end of the rod 21 while the second end 212 refers to the lower end of the rod 21.

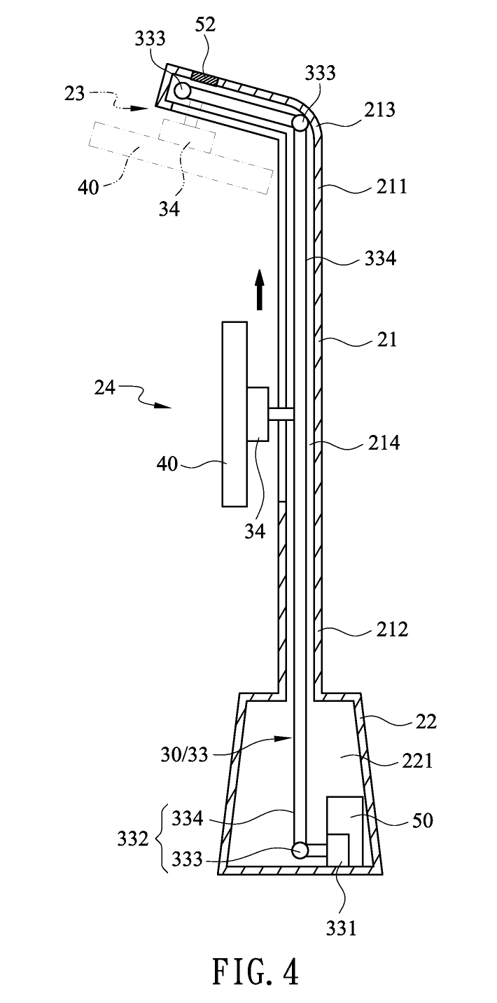

As can be seen in FIGS. 2 and 4, the rod 21 may further include a bent portion 213 extending from the first end 211 of the rod 21, so that the rod 21 has an overhanging arm. Meantime, referring to FIGS. 2 through 4, the lamp support 20 may further comprise a base 22 that is connected with the second end 212 of the rod 21 so that the lamp support 20 can be placed on the ground stably on the strength of the base 22. The base 22 may include therein an accommodating space 221 that is intercommunicated with the chamber 214 of the rod 21 so that the accommodating space 221 can also serve to accommodate the control module 50 and the elevator module 30.

As shown in FIG. 2, the elevator module 30 is disposed in the lamp support 20. The elevator module 30 may be a pneumatic elevator module 31, a hydraulic elevator module 32, or a motor transmission device 33.

Referring to FIG. 3, the pneumatic elevator module 31 or the hydraulic elevator module 32 can be settled in the lamp support 20. More particularly, the pneumatic elevator module 31 or the hydraulic elevator module 32 is received in the chamber 214 of the rod 21 and the accommodating space 221 of the base 22, while an extending shaft 311 of the pneumatic elevator module 31 or the hydraulic elevator module 32 has one end abutting against a bottom of the base 22 so as to provide a hold to the extending shaft 311. Besides, the pneumatic elevator module 31 or the hydraulic elevator module 32 may have a connecting portion 34. The connecting portion 34 is attached to the extending shaft 311 and exposed outside the rod 21 to be connected with the lighting-displaying module 40 so that the lighting-displaying module 40 elevates or lowers with movements of the elevator module 30.

According to FIG. 4, the elevator module 30 may be alternatively a motor transmission device 33, which includes a motor 331, a transmission assembly 332, and the connecting portion 34.

The motor 331 is installed in the lamp support 20, and more particularly, in the chamber 214 of the rod 21 (not shown), or in the accommodating space 221 of the base 22 (as shown in FIG. 4).

The transmission assembly 332 has a wheel set 333 and a belt 334. The wheel set 333 may include a plurality of gear wheels settled in the lamp support 20 to be driven to rotate by the motor 331. In the embodiment where the lamp support 20 has only the rod 21 without the overhanging arm, the gear wheels of the wheel set 333 are disposed at the first end 211 and the second end 212 of the rod 21. To state differently, the gear wheels of the wheel set 333 are disposed at two ends of the rod 21, respectively (not shown). In the embodiment where the lamp support 20 has the bent portion 213 and the overhanging arm, the gear wheels of the wheel set 333 have to be disposed at the bent portion 213 in addition to the first end 211 and the second end 212 of the rod 21. That is, in addition to the upper end and the lower end of the rod 21, the bent portion 213 of the lamp support 20 has to be equipped with the gear wheel of the wheel set 333.

The belt 334 may be a drive belt or a chain to be mounted around the wheel set 333 so that the belt 334 moves along with the wheel set 333. In other words, the motor 331 rotates the wheel set 333 to drive the belt 334 so that the gear wheels act as turning points of the movements of the belt 334.

The connecting portion 34 is provided on the belt 334 and exposed outside the rod 21 to be connected with the lighting-displaying module 40 so that the lighting-displaying module 40 elevates or lowers with movements of the belt 334 of the elevator module 30.

As shown in FIG. 2, the lighting-displaying module 40 may be an LED lighting-displaying module that has a plurality of light-emitting diodes arranged as an LED array. Thereby, the lighting-displaying module 40 serves to not only provide competent brightness of illumination, but also display information on the strength of the display variety of the LED array.

Referring to FIGS. 3 and 4, the lighting-displaying module 40 is connected with the elevator module 30 so as to elevate or lower with movements of the elevator module 30. Moreover, the lighting-displaying module 40 elevating to a first location 23 along the lamp support 20 is switched to give illumination while the lighting-displaying module 40 lowering to a second location 24 along the lamp support 20 is switched to display information. The first location 23 of the lamp support 20 is near the first end 211 of the rod 21, or at the bent portion 213 of the rod 21, or at the upper end of the rod 21, so that the lighting-displaying module 40 is hung overhead the rod 21 by the overhanging arm extending from the bent portion 213, and provides illumination with the illuminating angle conforming to the applicable regulations. On the other hand, the second location 24 of the lamp support 20 is generally at the middle portion of the rod 21 and equal to the height of normal road users' sighting line, so that the information displayed by the lighting-displaying module 40 is conspicuous to road users.

According to FIGS. 3 and 4, the control module 50 is electrically connected with the elevator module 30 so as to control the elevator module 30 to move. Moreover, when the lighting-displaying module 40 is at the first location 23, the control module 50 switches the lighting-displaying module 40 to an illumination mode for illuminating. When the lighting-displaying module 40 is at the second location 24, the control module 50 switches the lighting-displaying module 40 to a display mode for displaying. Besides, the control module 50 may have a display control unit (not shown) for controlling contents to be displayed by the lighting-displaying module 40 in a display mode.

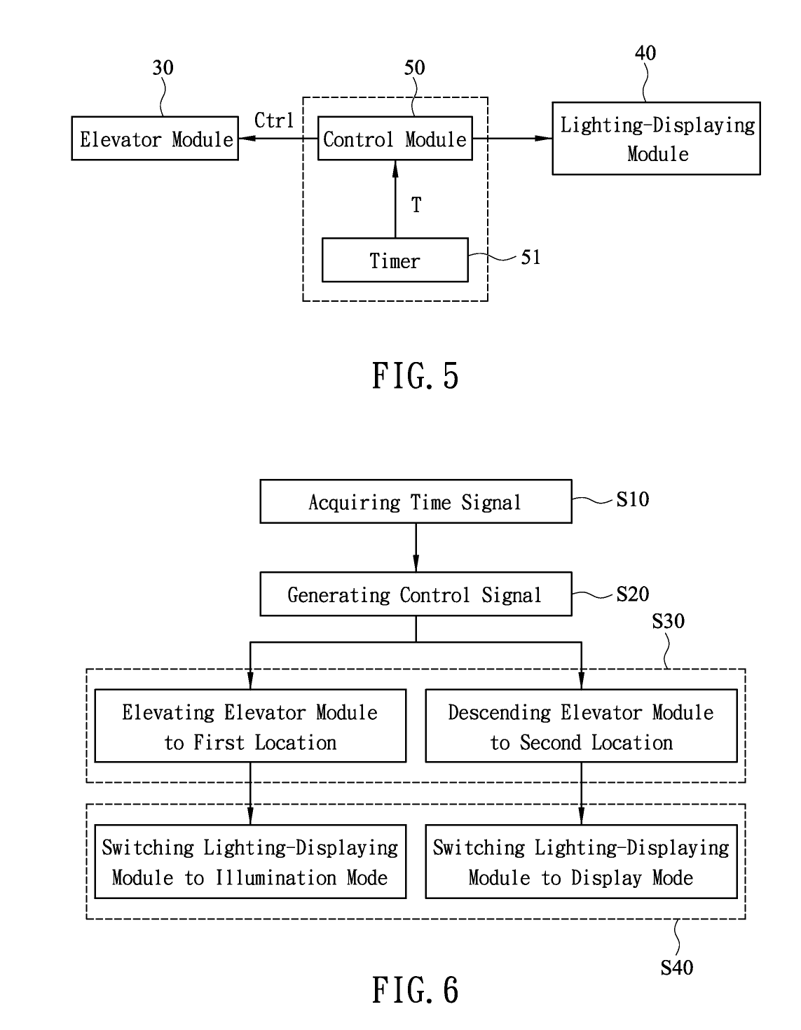

Referring to FIG. 5, the control module 50 may have a timer 51. As shown in FIG. 6, the control module 50 having the timer 51 is able to perform the following steps: acquiring a time signal S10; generating a control signal S20; elevating or lowering the elevator module according to the control signal S30; and switching the lighting-displaying module into the illumination mode or the display mode S40.

In the step of acquiring the time signal S10, referring to FIG. 5, the timer 51 of the control module 50 is preprogrammed with at least one time signal T so that the control unit 50 acquires the time signal T from the timer 51 and controls the elevator module 30 to move according to the time signal T. For instance, the time signal T may be set differently according to different sunlit durations in different seasons so that the control unit 50 can switch the lighting-displaying module 40 for illuminating after sunset. Or, the control unit 50 can switch the lighting-displaying module 40 for displaying when sunlight is sufficient.

In the step of generating the control signal S20, the control unit 50 generates the control signal Ctrl according to the time signal T, as shown in FIG. 5. That is, the control unit 50 generates the control signal Ctrl depending on its receipt or the contents of the time signal T.

In the step of elevating or lowering the elevator module according to the control signal S30, the control unit 50 elevates the elevator module 30 to the first location 23 or lowers the elevator module 30 to the second location 24 according to the control signal Ctrl, so that the elevator module 30 positions the lighting-displaying module 40 at an appropriate location for illuminating or displaying.

In the step of switching the lighting-displaying module into the illumination mode or the display mode S40, since the lighting-displaying module 40 needs to be switched between the modes for illuminating or displaying, when the lighting-displaying module 40 is at the first location 23, the control module 50 switches the lighting-displaying module 40 into the illumination mode for illuminating, and when the lighting-displaying module 40 is at the second location 24, the control module 50 switches the lighting-displaying module 40 into the display mode for displaying.

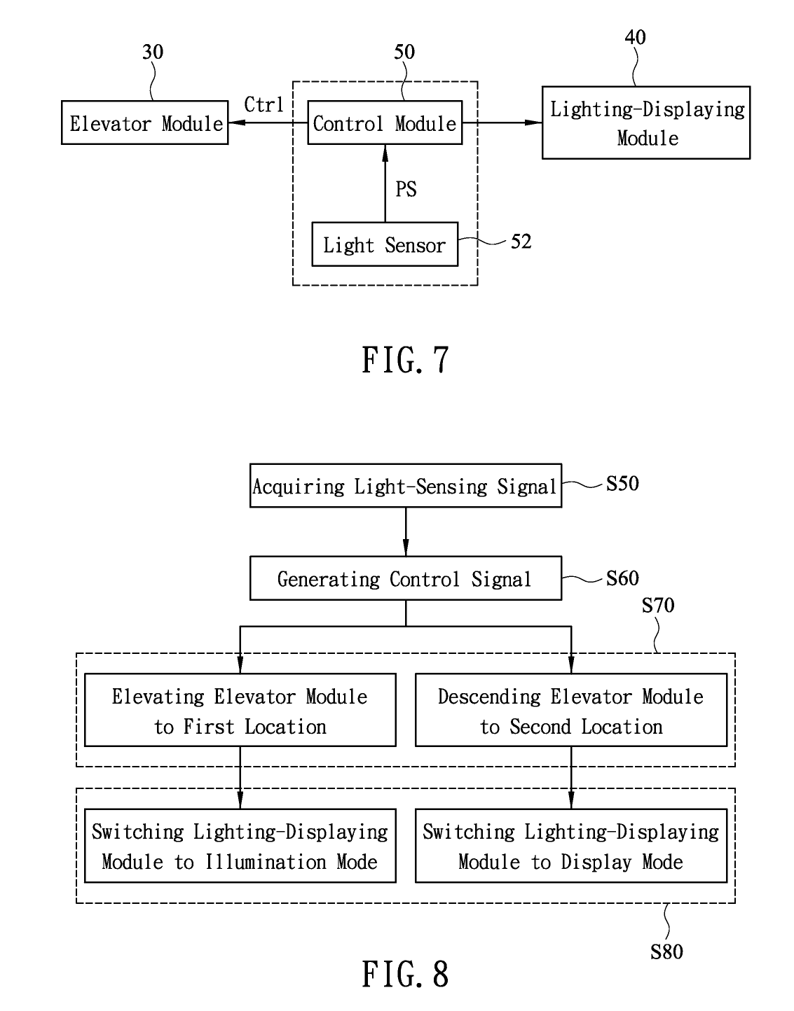

As shown in FIG. 7, the control module 50 may have a light sensor 52. The light sensor 52 may also be settled on the lamp support 20, as shown in FIG. 2 for detecting the intensity of ambient sunlight. The light sensor 52 generates a light-sensing signal PS for the control module 50 to refer and elevate or lower the elevator module 30 accordingly.

Referring to FIG. 8, the control module 50 having the light sensor 52 is able to perform the following steps: acquiring a light-sensing signal S50; generating a control signal S60; elevating or lowering the elevator module according to the control signal S70; and switching the lighting-displaying module into the illumination mode or the display mode S80.

In the step of acquiring the light-sensing signal S50, referring to FIG. 7, the light sensor 52 of the control module 50 serves to generate the light-sensing signal PS by detecting the intensity of ambient sunlight. For example, when sunlight is sufficient, the light-sensing signal PS has a high value and when sunlight is insufficient, the light-sensing signal PS has a low value.

In the step of generating the control signal S60, the control module 50 generates the control signal Ctrl according to the light-sensing signal PS. For example, when the light-sensing signal PS is higher than a preset threshold, it is indicated that sunlight is sufficient and no additional illumination is needed. Thus, the control signal Ctrl generated by the control module 50 makes the elevator module 30 lower to the second location 24. On the contrary, when the light-sensing signal PS is lower than the preset threshold, it is indicated that sunlight is insufficient and additional illumination is needed. Thus, the control signal Ctrl generated by the control module 50 makes the elevator module 30 elevate to the first location 23.

In the step of elevating or lowering the elevator module according to the control signal S70, the control module 50 elevates the elevator module 30 to the first location 23 or lowers the elevator module 30 to the second location 24. Thereby, the elevator module 30 in turn drives the lighting-displaying module 40 to move and position the lighting-displaying module 40 at an appropriate location for illuminating or displaying.

In the step of switching the lighting-displaying module into the illumination mode or the display mode S80, since the lighting-displaying module 40 needs to be switched between the modes for illuminating or displaying, when the lighting-displaying module 40 is at the first location 23, the control module 50 switches the lighting-displaying module 40 into the illumination mode for illuminating, and when the lighting-displaying module 40 is at the second location 24, the control module 50 switches the lighting-displaying module 40 into the display mode for displaying.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A lamp structure for illuminating and displaying, comprising:
a lamp support having a rod;
an elevator module combined with the lamp support;
a lighting-displaying module combined with the elevator module to elevate or lower with movements of the elevator module, wherein the lighting-displaying module elevating with the elevator module to a first location of the lamp support is for illuminating, while the lighting-displaying module lowering with the elevator module to a second location of the lamp support is for displaying; and
a control module electrically connected with the elevator module for controlling the elevator module to elevate or lower and switching the lighting-displaying module between an illumination mode for illuminating and a display mode for displaying.

2. The lamp structure of claim 1, wherein the rod further includes a bent portion extending from a first end of the rod.

3. The lamp structure of claim 2, wherein the lamp support further comprises a base connected with a second end of the rod.

4. The lamp structure of claim 1, wherein the lamp support further comprises a base connected with a second end of the rod.

5. The lamp structure of claim 1, wherein the elevator module is a pneumatic elevator module and settled in the lamp support, the elevator module having a connecting portion that is exposed outside the rod and connected with the lighting-displaying module.

6. The lamp structure of claim 1, wherein the elevator module is a hydraulic elevator module and settled in the lamp support, the elevator module having a connecting portion that is exposed outside the rod and connected with the lighting-displaying module.

7. The lamp structure of claim 1, wherein the elevator module includes:
a motor settled in the lamp support;
a transmission assembly having a wheel set, that is settled in the lamp support and powered by the motor, and a belt that is mounted around the wheel set and driven by the wheel set to move; and
a connecting portion provided on the belt and exposed outside the rod to be connected with the lighting-displaying module.

8. The lamp structure of claim 7, wherein the wheel set is settled at a first end and a second end of the rod.

9. The lamp structure of claim 7, wherein the wheel set is settled at a first end, a second end, and a bent portion of the rod.

10. The lamp structure of claim 1, wherein the lighting-displaying module is an LED lighting-displaying module.

11. The lamp structure of claim 1, wherein the control module includes a timer that is preprogrammed with at least one time signal so that the control unit controls the elevator module to move according to the time signal.

12. The lamp structure of claim 11, wherein the control module performs steps of:
acquiring the time signal;
generating a control signal according to the time signal; and
elevating or lowering the elevator module according to the control signal, wherein the lighting-displaying module elevating with the elevator module to the first location is switched to the illumination mode for illuminating, while the lighting-displaying module lowering with the elevator module to the second location is switched to the display mode for displaying.

13. The lamp structure of claim 1, wherein the control unit has a light sensor that is settled on the lamp support and generates at least one light-sensing signal so that the control unit controls the elevator module to move according to the light-sensing signal.

14. The lamp structure of claim 13, wherein the control module performs steps of:
acquiring the light-sensing signal;
generating a control signal according to the light-sensing signal; and
elevating or lowering the elevator module according to the control signal, wherein the lighting-displaying module elevating with the elevator module to the first location is switched to the illumination mode for illuminating, while the lighting-displaying module lowering with the elevator module to the second location is switched to the display mode for displaying.

15. The lamp structure of claim 1, wherein the control module has a display-control unit for controlling contents to be displayed by the lighting-displaying module in the display mode.
